(19) United States
(12) Patent Application Publication
(10) Pub. No.: US 2018/0335063 A1
(43) Pub. Date: Nov. 22, 2018

(54) Locking Extension Pole

(71) Applicant: Hopkins Manufacturing Corporation, Emporia, KS (US)

(72) Inventor: Marcus Gooden, LomaLinda, CA (US)

(73) Assignee: Hopkins Manufacturing Corporation, Emporia, KS (US)

(21) Appl. No.: 15/597,224

(22) Filed: May 17, 2017

(51) Int. Cl. F16B 7/10; B25G 1/04; F16B 7/14

(52) U.S. Cl. CPC F16B 7/10; B25B 13/481; F16B 7/14; B25G 1/04

(57) ABSTRACT

A locking pole assembly is provided that consists of two telescoping poles that are movable along their longitudinal axis to adjust the effective length of the pole assembly. The pole assembly can be extended to various lengths by manipulating a rotatable grip that is coupled to a locking mechanism. Rotation of the grip about the longitudinal axis of the pole assembly in one direction unlocks the lock mechanism and then rotating the grip the other direction will lock the lock mechanism.

### FIELD OF THE INVENTION

The present disclosure is directed generally to flow through extension poles used for cleaning purposes, such as car washing, and more particularly to poles having a locking mechanism to lock the pole at a fixed length.

### BACKGROUND

Adjustable length poles are well known in the art. Typically, two (or more) poles will engage one another in telescoping relation and lock in place via a spring loaded detent or threaded locking collar once the desired length is achieved. In each instance the locking mechanism is externally exposed and thus subject to damage through dropping of the pole or other normal wear and tear.

Accordingly, there is a need in the art for a locking pole that conceals the locking mechanism.

### SUMMARY

The present disclosure is directed to a locking pole assembly comprising two telescoping poles that are movable along their longitudinal axis to adjust the length of the pole assembly. The pole assembly can be extended to various lengths by unlocking the lock mechanism and then rotating the lock mechanism when the pole assembly is at its desired length.

According to an aspect is a telescoping pole assembly, comprising a first pole extending along a longitudinal axis; a second pole extending along the longitudinal axis and in telescoping relation to the first pole; and a grip attached to the first pole for manual rotation about the longitudinal axis and positioned at the intersection of the first pole and said second pole, the grip comprising a locking ring fixed to the grip such that it is rotatable about the longitudinal axis, and a cavity formed within the grip and in the longitudinal pathway of the second pole, wherein the locking ring is rotatably movable into and out of engaged relation with the cavity and when in engaged relation to the cavity blocks longitudinal movement of the second pole.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a first perspective view of a locking extension pole assembly, in accordance with an embodiment.

FIG. 2 is a front elevation view thereof.

FIG. 3 is a rear elevation view thereof.

FIG. 4 is a first side elevation view thereof.

FIG. 5 is a second side elevation view thereof.

FIG. 6 is a top plan view thereof.

FIG. 7 is a bottom plan view thereof.

FIG. 8 is cross-sectional view taken along section line 8, 9-8, 9 of FIG. 1 showing the locking mechanism in an unlocked position.

FIG. 9 is cross-sectional view taken along section line 8, 9-8, 9 of FIG. 1 showing the locking mechanism in a locked position.

### DETAILED DESCRIPTION OF EMBODIMENTS

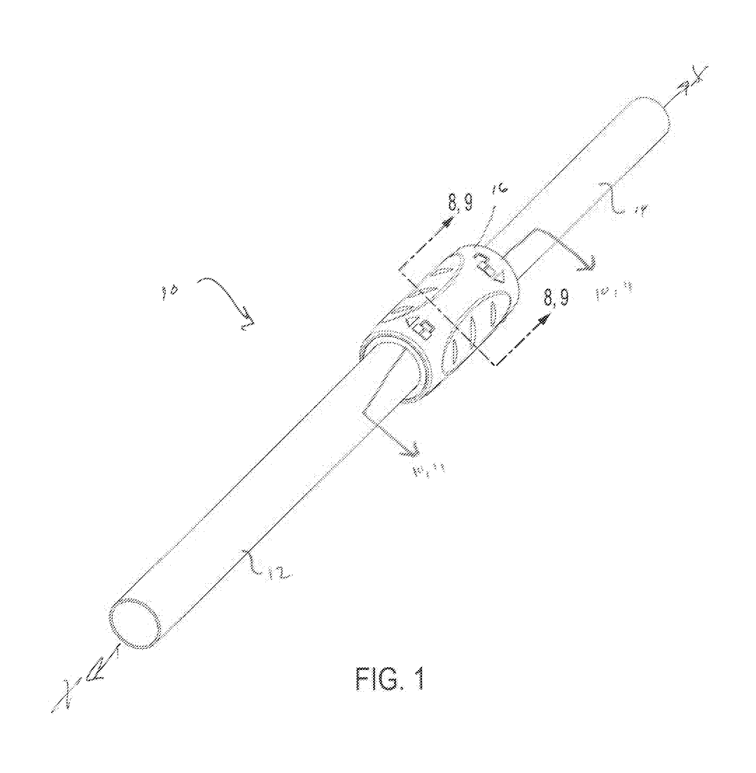

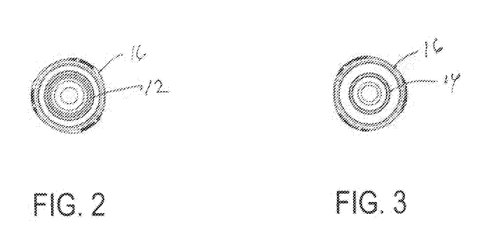

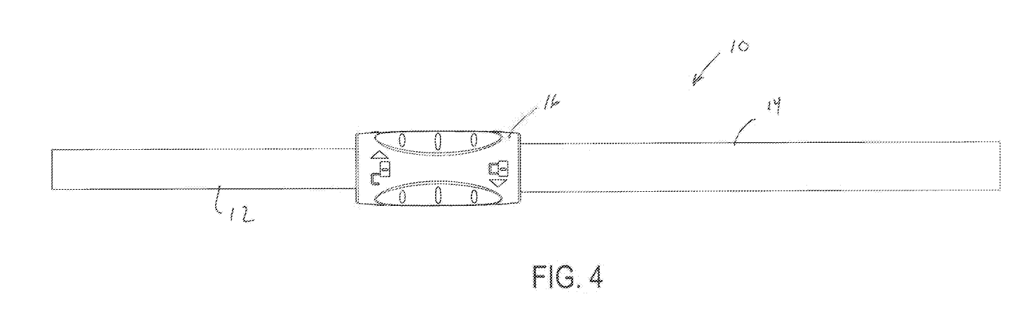

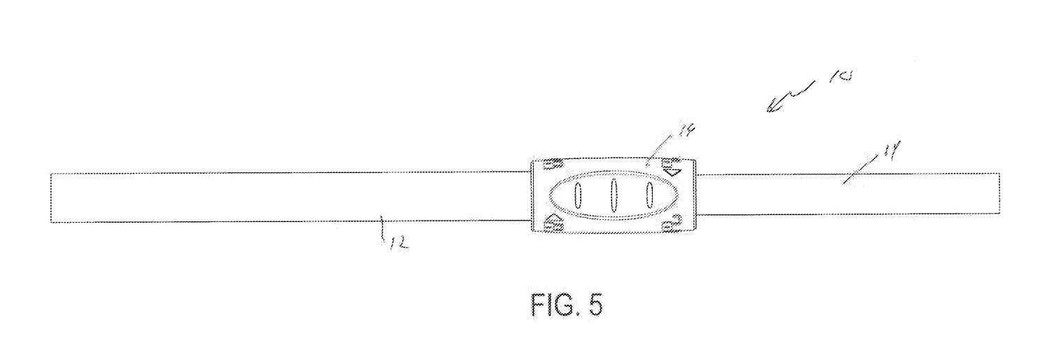

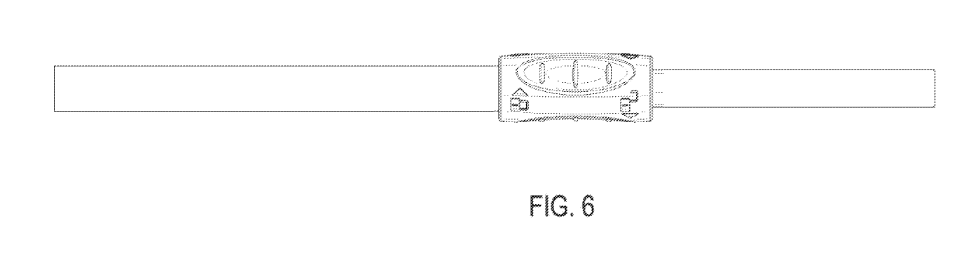

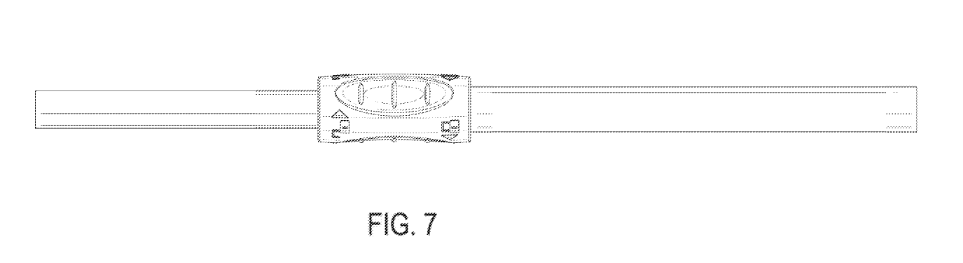

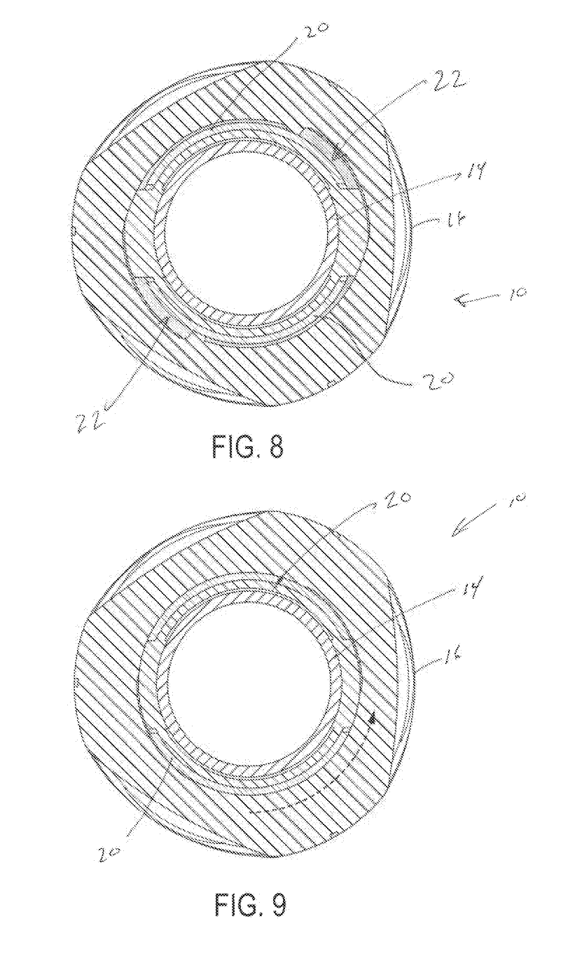

The present disclosure describes a telescoping pole assembly having a manually rotatable grip that effects locking and unlocking of the telescoping poles. Referring to FIGS. 1-7, in one embodiment, is the telescoping pole assembly, designated generally by reference numeral 10, comprising first and second poles 12, 14, that telescope relative to one another along their shared longitudinal axis X-X. One pole 12 or 14 can be attached to a water supply, cleaning supply, etc., and a cleaning implement, such as a brush, can be attached to the opposing end of the other pole. A grip 16 is positioned at the intersection of the two poles 12, 14 and is manually rotatable about axis X-X to lock or unlock the poles 12, 14 relative to one another.

With reference to FIG.'S 8 and 9, the details of the locking mechanism, designated generally by reference numeral 18, may be seen. Locking mechanism 18 is housed within grip 16 and comprises locking rings 20 that, when rotated, engage (to lock the assembly) and disengage from (to unlock the assembly) corresponding cavities 22 formed within mechanism 18. When engaged in cavities 22, the locking rings 20 block/prevent telescoping longitudinal movement of poles 12, 14. By rotating grip 16 when locking mechanism 18 is locked, locking mechanism 18 is rotated such that locking rings 20 disengage from cavities 22 and no longer obstruct the longitudinal movement of poles 12, 14 relative to one another.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

What is claimed is:

1. A telescoping pole assembly, comprising:
a. a first pole extending along a longitudinal axis;
b. a second pole extending along said longitudinal axis and in telescoping relation to said first pole;
c. a grip attached to said first pole for manual rotation about said longitudinal axis and positioned at the intersection of said first pole and said second pole, said grip comprising a locking ring fixed to said grip such that it is rotatable about said longitudinal axis, and a cavity formed within said grip and in the longitudinal pathway of said second pole, wherein said locking ring is rotatably movable into and out of engaged relation with said cavity and when in engaged relation to said cavity blocks longitudinal movement of said second pole.
